(19) United States
(12) Patent Application Publication
(10) Pub. No.: US 2022/0311131 A1
(43) Pub. Date: Sep. 29, 2022

(54) COMMUNICATION SYSTEM WITH PORTABLE INTERFACE MECHANISM AND METHOD OF OPERATION THEREOF

(71) Applicant: M2SL Corporation, Fort Lee, NJ (US)

(72) Inventor: Syngbum Kim, Fort Lee, NJ (US)

(21) Appl. No.: 17/490,212

(22) Filed: Sep. 30, 2021

Related U.S. Application Data
(60) Provisional application No. 63/167,581, filed on Mar. 29, 2021.

(51) Int. Cl. H01Q 1/28; H01Q 5/378; H01Q 21/00; H01Q 3/34

(52) U.S. Cl. CPC H01Q 1/288; H01Q 5/378; H01Q 21/0037; H01Q 3/34

(57) ABSTRACT

A communication system comprising: a satellite interface unit including: a steerable beam phase array antenna configured to receive a down-link satellite packet, wherein the steerable beam phase array antenna includes a parasitic layer and a waveguide interposer, a satellite Rx/Tx, coupled to the steerable beam phase array antenna, configured to decode the down-link satellite packet, a storage device, coupled to the satellite Rx/Tx, configured to store satellite data decoded from the down-link satellite packet, an interface module, coupled to the storage device, configured to encode and transfer the satellite data as a cellular communication packet, a WiFi packet, or a combination thereof when a local infrastructure is non-accessible.

### CROSS REFERENCE TO RELATED APPLICATION(S)

This application claims the benefit of U.S. Provisional Patent Application Ser. No. 63/167,581 filed Mar. 29, 2021, and the subject matter thereof is incorporated by reference herein.

### TECHNICAL FIELD

An embodiment of the present invention relates generally to a communication system, and more particularly to a system for high speed communication via a portable satellite interface.

### BACKGROUND

A user terminal is the device that is used by an end user to access the services provided by the wireless network. In satellite communication, user terminal plays a key role in establishing and maintaining satellite connections. Nowadays, the satellite communication with Low Earth Orbit (LEO) satellite is increasing. The LEO satellite communication provides low latency, short revisit interval, and dense coverage with many small satellites available for communication. LEO satellite communication to provides high speed and low latency communication. With LEO satellites it is possible to use relatively small antennas and integrated circuit chip components.

User terminal systems can require sensitive electronic assemblies in order to manage the low level of radio frequency (RF) signal down-loaded from the LEO satellite. The user terminal systems can be quite large and require sufficient electrical support structure to make them immoveable. Some of the portable versions of the user terminal systems can be built into a twenty foot long van or bus with large satellite dishes mounted on the roof. While these user terminal systems are considered portable, they are limited to roadway accessible spaces that can provide the required electrical supply.

Thus, a need still remains for a communication system with portable interface mechanism to enable Internet and cellular communication on a world-wide basis. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an apparatus, including a communication system, including: a satellite interface unit including: a steerable beam phase array antenna configured to receive a down-link satellite packet, wherein the steerable beam phase array antenna includes a parasitic layer and a waveguide interposer, a satellite Rx/Tx, coupled to the steerable beam phase array antenna, configured to decode the down-link satellite packet, a storage device, coupled to the satellite Rx/Tx, configured to store satellite data decoded from the down-link satellite packet, and an interface module, coupled to the storage device, configured to encode and transfer the satellite data as cellular communication packets, the WiFi hotspot, or a combination thereof when a local infrastructure is non-accessible.

An embodiment of the present invention provides a method including: receiving a down-link satellite packet through a parasitic layer and a waveguide interposer a steerable beam phase array antenna; decoding the down-link satellite packet; storing satellite data decoded from the down-link satellite packet; and encoding and transferring the satellite data as a cellular communication packet, a WiFi packet, or a combination thereof when a local infrastructure is non-accessible.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an example of a functional block diagram of a communication system with portable interface mechanism in an embodiment of the present invention.

FIG. 2 is an example of an exploded view of a panel of the steerable beam phase array antenna of FIG. 1 in an embodiment.

FIG. 3 is an example of an assembly drawing of a multi-panel embodiment of the steerable beam phase array antenna in an embodiment of the present invention.

FIG. 4 is an example of an assembly drawing of a multi-panel embodiment of the steerable beam phase array antenna in a further embodiment of the present invention.

FIG. 5 is an architectural block diagram of the satellite interface unit in a further embodiment of the present invention.

FIG. 6 is a flow chart of a method of operation of a communication system in an embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

As an example, satellites in low-Earth orbit (LEO) can be at an altitude of between 160 to 2,000 km (99 to 1200 mi) above the Earth's surface. A satellite below this altitude can suffer from orbital decay leading to a rapid descent into the atmosphere, either burning up or crashing on the surface. Satellites at this altitude also have an orbital period (i.e. the time it will take them to orbit the Earth once) of between 88 and 127 minutes. A geosynchronous orbit is a high Earth orbit that allows satellites to match Earth's rotation. Located at 22,236 miles (35,786 kilometers) above Earth's equator, this position is a valuable spot for monitoring weather, communications and surveillance, but presents a prohibitively high latency, that can be greater than 500 milli-seconds, in a communication exchange.

As an example, three parameters can be manipulated in order to optimize the capacity of a communications link — bandwidth, signal power and channel noise. An increase in the transmit power level results in an increase of the communication link throughput, likewise a decrease in power will result in the opposite effect reducing the throughput. Also, for example, another way to improve the link throughput would be to increase the size of the receiving antenna in order to have a higher level of energy received at a receiver. But this is where operational constraints become apparent, as, an increase in the size of the receiving antenna could lead to an unfeasible installation for a personal or business application.

User terminal systems can provide access to the LEO satellite systems utilizing mobile antennas and electronic packages. The antenna can receive the downlink signal or beacon from satellite and transmits the uplink signal to satellite. The antenna needs very sensitive components and low noise amplifier blocks to amplify the satellite signal. The conversion system and components can be selected according to the communication protocol and system parameters to support the satellite specification and local interface demands.

The term “module” referred to herein can include specialized hardware supported by software in an embodiment of the present invention in accordance with the context in which the term is used. For example, the software can be machine code, firmware, embedded code, and application software. Also, for example, the specialized hardware can be circuitry, processor, computer, integrated circuit, integrated circuit cores, a pressure sensor, an inertial sensor, a microelectromechanical system (MEMS), passive devices, or a combination thereof. The term “abut” referred to herein is defined as two components in direct contact with each other with no intervening elements. The term “couple” referred to herein is defined as multiple elements linked together by wired or wireless means. The term “local infrastructure” referred to herein is defined as cell towers, networking apparatus, repeaters, or a combination thereof used for cellular communication. The term “non-accessible” referred to herein is defined as unable to be accessed or communication problems due to, as examples, equipment failure, weak signals, power loss, accidents, natural disaster, or sabotage.

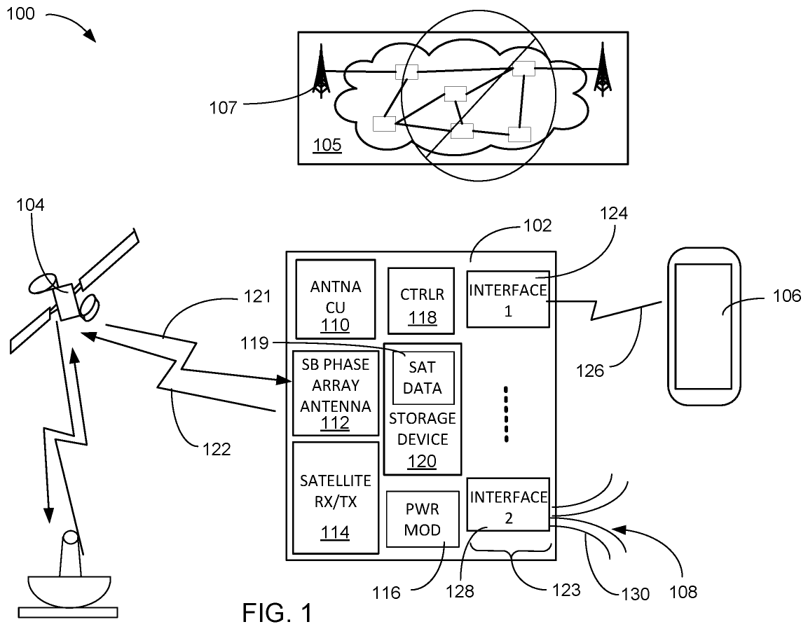

Referring now to FIG. 1, therein is shown an example of a functional block diagram of a communication system 100 with portable interface mechanism in an embodiment of the present invention. The communication system 100 is depicted in FIG. 1 as a functional block diagram of the communication system 100 with a satellite interface unit 102.

The satellite interface unit 102 can be an integrated hardware structure that can couple to a satellite 104 to provide communication. As an example, the satellite interface unit 102 can provide communication in a region whether a local infrastructure 105 is non-accessible, unavailable, or disabled due to damage or loss of power. The local infrastructure 105 can be the communication support network in a local area, including wired and wireless networks, cell phone towers, repeaters, or routers used for delivery of emergency communication services, mobile phone service, Internet services, or a combination thereof

The satellite interface unit 102 can provide support for the satellite 104 in low-Earth orbit (LEO), at an approximate altitude of between 160 to 2,000 km (99 to 1200 mi) above the Earth's surface, or geosynchronous Earth orbit (GEO), which is a high Earth orbit located at 22,236 miles (35,786 kilometers) above Earth's equator, that allows satellites to match Earth's rotation. As an example, the satellite 104 can transmit, receive, or a combination thereof a Ka-band signal in a defined frequency range of 26.0 to 40.0 GHz as well as the Ku-band signal in a defined frequency range of 12.0 to 18.0 GHz. The satellite interface unit 102 can be configured to support other orbit altitudes and frequency spectrums.

The satellite interface unit 102 can provide a communication link between the satellite 104 and a communication device 106 including as examples mobile devices supporting third generation telecommunication (3G), long term evolution (LTE), fourth generation telecommunication (4G), fifth generation telecommunication (5G), or a combination thereof. The satellite interface unit 102 can also provide a communication link between the satellite 104 and act as a wireless fidelity application (WiFi) hotspot 108. The WiFi hotspot 108 can include support for computers, laptops, tablets that access a local area network (LAN), a wide area network (WAN), a Fiber-Channel token ring (FC), or a combination thereof. The satellite interface unit 102 can also provide a communication link between one or more of the satellite 104 and the communication device 106.

The communication system 100 can include an antenna control unit 110 to analyze and track the satellite signals and beacon signals transmitted from the satellite 104 in low-Earth orbit (LEO). The antenna control unit 110 can assist in switching between multiple of the satellite 104 that move into or out of range of the communication system 100. The antenna control unit 110 can control a steerable beam phase array antenna 112 that provides the ability to maintain communication with the satellite 104 as it moves through the field of view of the communication system 100. The steerable beam phase array antenna 112 can be a multi-panel, foldable satellite antenna capable of sending and receiving signals in the Ka-band frequency spectrum and the Ku-band frequency spectrum. The construction of the steerable beam phase array antenna 112 can provide tracking and communication for the satellite 104 in low-Earth orbit. The antenna control unit 110 can enable or disable paths within the steerable beam phase array antenna 112 that can selectively transmit and receive down-link satellite packets 121 and up-link satellite packets 122 to specific ones of the satellite 104.

By way of an example, in a disaster situation, the satellite interface unit 102 can provide basic and advanced communication services for anyone attempting to communicate without the use of the local infrastructure 105. The satellite interface unit 102 can be configured to support other interface structures (not shown), including Bluetooth, Near Field Communication, laser communication, fiber optics, or a combination thereof.

The satellite interface unit 102 can include the steerable beam phase array antenna 112 coupled to a satellite receiver/transmitter (Rx/Tx) 114 configured to communicate with the satellite 104 orbiting the Earth in the LEO position. As an example, the steerable beam phase array antenna 112 can be configured to support frequencies in a Ku frequency band, in the range of 13.4 GHz through 14.9 GHz, in a Ka frequency band, in the range of 27.5 GHz through 32.5 GHz, in a 5G frequency band, targeted for 15 GHz or 28 GHz, or a combination thereof. It is understood that other frequency ranges can be supported in both higher frequency and lower frequencies. The steerable beam phase array antenna 112 can be a parasitic patch layer adhered to a feed horn array coupled to a waveguide interposer and a waveguide interface for communicating with the satellite Rx/Tx 114.

A power module 116 can provide independent power to operate the satellite interface unit 102 and provide auxiliary power for the communication device 106. The power module 116 can include batteries, solar power, a generator interface, wind mill power, or a combination thereof The power module 116 can include any sustainable power source that will provide sufficient energy to enable the communication through the satellite interface unit 102.

The satellite interface unit 102 can also include a unit controller 118 configured to manage the operations of the satellite interface unit 102 including managing a satellite data 119. The unit controller 118 can be implemented as a processor, a micro-computer, a micro-processor core, an application specific integrated circuit (ASIC) an embedded processor, a microprocessor, a hardware control logic, a hardware finite state machine (FSM), a digital signal processor (DSP), or a combination thereof. The satellite data 119 can be the payload from the down-link satellite packets 121 or the preparation data for encoding the up-link satellite packets 122. The unit controller 118 can access a storage device 120 that can provide a data storage function for receiving and reformatting the down-link satellite packets 121 of the satellite data 119 for transfer to the communication device 106 or the WiFi hotspot 108. The unit controller 118 can access the storage device 120 that can provide a data storage function for assembling the satellite data 119 requests from the communication device 106 and the WiFi hotspot 108 that can be submitted to the Satellite Rx/Tx 114 to generate the up-link satellite packets 122.

The storage device 120 can include a hard disk drive (HDD), a solid-state storage device (SSD), non-volatile memory, volatile memory, or a combination thereof. The physical capacity of the storage device 120 can be configured based on the number and type of interface modules 123 that are to be activated by the satellite interface unit 102.

By way of an example, the satellite interface unit 102 can be configured with a first interface module 124 that can provide cellular communication packets 126 to the communication device 106, a second interface module 128 that can provide the WiFi hotspot 108 for the communication device 106 or act as the WiFi hotspot 108 for additional computers within a 1 kilometer range of the satellite interface unit 102. It is understood that other types of the interface modules 123 can be installed in the satellite interface unit 102 in order to address the communication needs of a region (not shown) that has the local infrastructure 105 non-accessible or disabled due to damage or loss of power.

It is understood that the satellite interface unit 102 can provide needed satellite communication options, when the local infrastructure 105 cannot support the communication requirement for the region. The lack of availability of the local infrastructure could be caused by natural disaster, man-made or naturally occurring power loss, damage to cell towers 107, or communication traffic overload due to some calamity. The satellite interface unit 102 can provide a configurable communication interface for mobile applications, including police and fire department vehicles, private vehicles, military, commercial, and private water vessels, military, commercial, or private aircraft.

The satellite interface unit 102 can provide multiple communication types in an off-the-grid environment. Many remote locations rely on the satellite 104 for basic communication and Internet services. The satellite interface unit 102 can include the antenna control unit 110 for tracking and switching between multiple of the satellite 104. The communication system 100 can be used in multiple environments including an automobile, a train, a motorcycle, an airplane, a boat, a bicycle, or the like. The communication system 100 of the present invention can quickly provide a communication infrastructure for multiple users in regions where the local infrastructure 105 is non-accessible due to lack of power or natural disasters have disabled any of the local infrastructure 105 that may have been present.

It has been discovered that the communication system 100 can convert the satellite data 119 to provide the cellular communication packets 126 and WiFi packets 130 for the communication device 106, the WiFi hotspot 108, or a combination thereof whether or not the local infrastructure 105 is non-accessible, disabled, or missing completely. Since the satellite interface unit 102 can be configured for communicating with specific ones of the satellite 104 and provide multiple of the interface modules 123 to address communication issues that previously required a base station the size of a house that cannot be transported or quickly configured to address outages that can befall a region. It is understood that the frequencies of the cellular communication packets 126, the WiFi packets 130, the down-link satellite packets 121, the up-link satellite packets 122 can provide support for hundreds of users of the cell phone 106 and the WiFi hotspot 108.

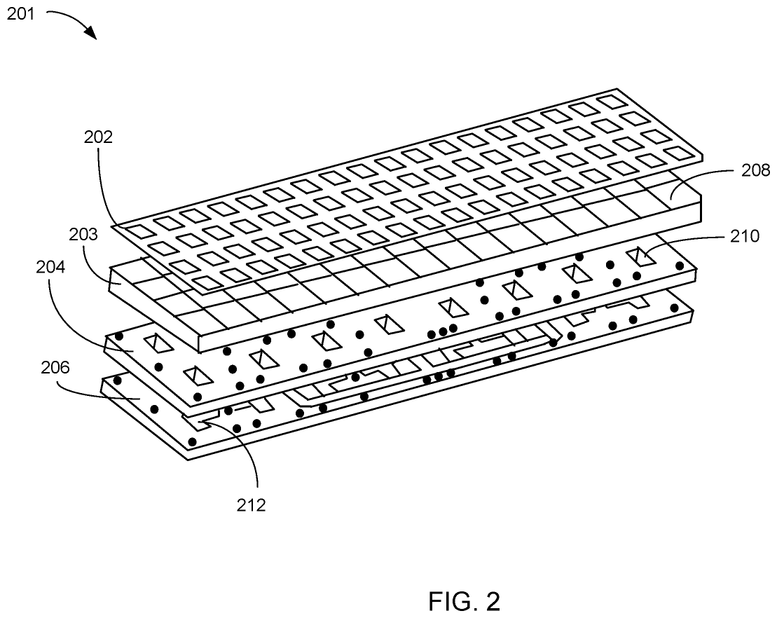

Referring now to FIG. 2, therein is shown an exploded view of a panel 201 of the steerable beam phase array antenna 112 of FIG. 1 in an embodiment. The steerable beam phase array antenna 112 can be formed by joining multiple of the panel 201, which include a parasitic patch layer 202, a feed horn array 203, a waveguide interposer 204 and a waveguide interface board 206 that can direct the frequencies of the down-link satellite packets 121 of FIG. 1 to the satellite Rx/Tx 114 of FIG. 1.

By way of an example, the parasitic patch layer 202 can be a thin film layer adhered to the feed horn array 203. The parasitic patch layer 202 can be the thin film layer patterned with a conductive layer configured to allow directional adjustments to the down-link satellite packets 121 received from the satellite 104 of FIG. 1 and the up-link satellite packets 122 transmitted to the satellite 104. Continuing with the Example, the feed horn array 203 is shown having a four by 16 configuration. Each feed horn 208 can be configured to operate with three of the adjacent ones of the feed horn 208 to steer the down-link satellite packets 121 into the waveguide interposer 204. The embodiment of the panel 201 of the steerable beam phase array antenna 112 is suitable for communication with the satellite 104 of FIG. 1 in a low-Earth orbit (LEO) and using a Ka frequency spectrum in the range of 18.8 to 19.3 GHz down-link and 27.5 to 28.35 GHz up-link or the Ku frequency spectrum in the range of 10.7 to 12.7 GHz down-link and 14.0 to 14.5 GHz up-link.

The waveguide interposer 204 can abut the feed horn array 203. A tight seal between the waveguide interposer 204 and the feed horn array 203 can provide a low impedance path for the down-link satellite packets 121 at a received frequency in the Ka band specified as a frequency range of 18.8 GHz to 27.5 GHz. In a further embodiment the steerable beam phase array antenna 112 can also transmit the up-link satellite packets 122 and receive the down-link satellite packets 121 from a specific one of the satellite 104 in the low Earth orbit (LEO). In this example, the steerable beam phase array antenna 112 used to support the satellite 104 operating in the Ku frequency spectrum in the range of 10.7 to 12.7 GHz downlink and 14.0 to 14.5 GHz uplink.

The waveguide interposer 204 can have a waveguide opening 210 that is specific to the frequency used to communicate with the satellite 104. The waveguide opening 210 for the satellite 104 configured in LEO can have a dimension of 19.05 mm by 9.525mm of the rectangular shape of the waveguide openings 210. The waveguide opening is oriented so that four of the feed horn 208 are aligned with the input of the waveguide opening 210. This also allows the steerable beam phase array antenna 112 to use electronic tracking of the satellite 104.

The waveguide interface board 206 can abut the waveguide interposer 204, opposite the feed horn array 203. The waveguide interface board 206 can have a rectangular waveguide 212 formed on the surface that abuts the waveguide interposer 204. the openings of the rectangular waveguide 212 are aligned with the waveguide openings 210 of the waveguide interposer 204, forming an impedance matched structure that can pass the down-link satellite packets 121 with a gain of 30.0 dBi for the receiver in LEO configuration and a gain of 31.0 dBi for the transmitter of the steerable beam phase array antenna 112.

It has been discovered that multi-layer structure of the steerable beam phase array antenna 112 can improve gain of the antenna structure is assembled by joining the parasitic layer 202, the feed horn array 203, the waveguide interposer 204, and the waveguide interface board 206. By matching the impedance of the combined structure, the steerable beam phase array antenna 112 can boost the overall gain of the steerable beam phase array antenna 112 by 1 to 3 dB. In addition, the voltage standing wave ratio (VSWR) of the antenna is less than 2: 1, and the return loss is also lower than -10dB. Because the structure requires the up-link satellite packet 122 and the down-link satellite packets 121 to make a 90-degree turn between the waveguide interposer 204 and the waveguide interface board 206, a bulge structure was added to the waveguide interface board 206 to reduce the reactance of the circuit and optimized the transmission of the up-link satellite packet 122 and the down-link satellite packets 121.

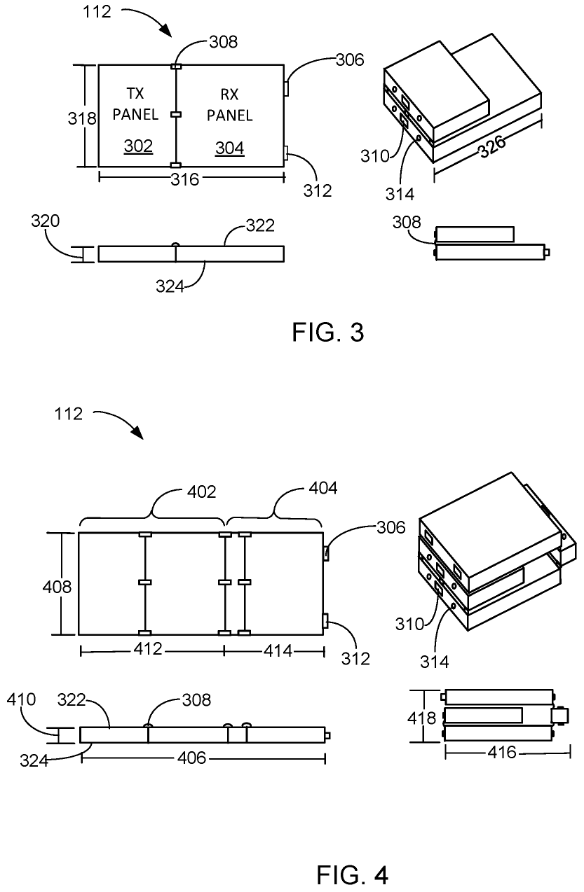

Referring now to FIG. 3, therein is shown an example of an assembly drawing of a multi-panel embodiment of the steerable beam phase array antenna 112 in an embodiment of the present invention. The assembly drawing of the steerable beam phase array antenna 112 depicts a multi panel embodiment of the steerable beam phase array antenna 112 for communicating with the satellite 104 in the Ku frequency spectrum or the Ka frequency spectrum. The multi panel embodiment of the steerable beam phase array antenna 112 can include a transmitter panel 302 coupled to a receiver panel 304.

A power control port 306 can be coupled to a vertical side of the receiver panel 304, opposite the transmitter panel 302. The transmitter panel 302 can be coupled to the receiver panel 304 by hinges 308. The hinges 308 can be formed of a non-conductive rubber or plastic material. A power control connector 310 can provide the electrical connection between the transmitter panel 302 and the receiver panel 304 for beam steering and biasing of the parasitic layer 202 of FIG. 2. The power control connector 310 can be coupled to the antenna control unit 110 of FIG. 1 through the power control port 306.

A data interface port 312 can be coupled to a vertical side of the receiver panel 304, opposite the transmitter panel 302. The data interface port 312 can provide a low noise path for receiving the down-link satellite packets 121 of FIG. 1 by the receiver panel 304 and an isolated path for higher power of the up-link satellite packet 122 of FIG. 1 sent to the transmitter panel 302. Radio frequency (RF) interface ports 314 can provide a low noise interconnection between the transmitter panel 302 and the receiver panel 304.

By way of an example, the receiver panel 304 can be physically larger that the transmitter panel 302. The larger size of the receiver panel 304 allows collection of more of the signal from the down-link satellite packets 121. The size of the transmitter panel 302 can be limited because of the additional power provided for the up-link satellite packet 122.

Continuing with the example, the steerable beam phase array antenna 112 can have an extended panel length 316 in the range of 250 mm to 300 mm and a panel width 318 in the range of 200 mm to 250 mm. A panel thickness 320 of the steerable beam phase array antenna 112 can be in the range of 35mm to 40mm, as measured along the edge between a top surface 322 and a bottom surface 324. The steerable beam phase array antenna 112 can also be folded for storage or transport by folding the transmitter panel 302 over the receiver panel 304 by the hinges 308. A folded panel length 326 can be in the range of 180 mm to 200 mm.

It has been discovered that the steerable beam phase array antenna 112 can support transmitting the up-link satellite packet 122 and receiving the down-link satellite packets 121 from the satellite 104 of FIG. 1 in the LEO position in both the Ku frequency spectrum and the Ka frequency spectrum without alteration. The steerable beam phase array antenna 112 can be controlled through the power control port 306 to provide beam steering and selective communication and tracking of the satellite 104. By folding the steerable beam phase array antenna 112, the parasitic layer 202 of the transmitter panel 302 can be protected and the size of the steerable beam phase array antenna 112 can be reduced for storage or transport.

Referring now to FIG. 4, therein is shown an example of an assembly drawing of a multi-panel embodiment of the steerable beam phase array antenna 112 in an alternative embodiment of the present invention. The assembly drawing of the steerable beam phase array antenna 112 depicts a multi panel embodiment of the steerable beam phase array antenna 112 for communicating with the satellite 104 of FIG. 1 in the Ku frequency spectrum or the Ka frequency spectrum. The multi panel embodiment of the steerable beam phase array antenna 112 can include a transmitter bi-fold antenna 402 coupled to a receiver bi-fold antenna 404.

By way of an example, the transmitter bi-fold antenna 402 can be formed by two of the panel 201 coupled by the hinges 308. The receiver bi-fold antenna 404 can be formed by two of the panel 201 coupled by the hinges 308. The transmitter bi-fold antenna 402 and the receiver bi-fold antenna 404 can be coupled by the hinges 308 in order to form the steerable beam phase array antenna 112 that can be folded for storage or transportation. This configuration of the steerable beam phase array antenna 112 can provide additional surface area for the transmission of the up-link satellite packet 122 of FIG. 1 and for the reception of the down-link satellite packets 121 of FIG. 1.

The steerable beam phase array antenna 112 can be configured to integrate components of the satellite Rx/Tx 114 of FIG. 1 and the antenna control unit 110 of FIG. 1. The integration of these components can reduce the electrical noise associated with transporting low amplitude RF signals between the steerable beam phase array antenna 112 and the satellite interface unit 102 of FIG. 1. The integration of the components of the satellite Rx/Tx 114 and the antenna control unit 110 can increase the thickness of the steerable beam phase array antenna 112, but can improve the signal quality of the down-link satellite packets 121 and the up-link satellite packet 122 accessed by the satellite interface unit 102.

The power control port 306 can be coupled to a vertical side of the receiver bi-fold antenna 404, opposite the transmitter bi-fold antenna 402. The transmitter bi-fold antenna 402 can be coupled to the receiver bi-fold antenna 404 by the hinges 308. The hinges 308 can be formed of a non-conductive rubber or plastic material. The power control connector 310 can provide the electrical connection between the transmitter bi-fold antenna 402 and the receiver bi-fold antenna 404 for beam steering and biasing of the parasitic layer 202 of FIG. 2. The power control connector 310 can be coupled to the antenna control unit 110 of FIG. 1 through the power control port 306.

The data interface port 312 can be coupled to a vertical side of the receiver bi-fold antenna 404, opposite the transmitter bi-fold antenna 402. The data interface port 312 can provide a low noise path for receiving the down-link satellite packets 121 of FIG. 1 by the receiver bi-fold antenna 404 and an isolated path for higher power of the up-link satellite packet 122 of FIG. 1 sent to the transmitter bi-fold antenna 402. The radio frequency (RF) interface ports 314 can provide a low noise interconnection between the transmitter bi-fold antenna 402 and the receiver bi-fold antenna 404.

By way of an example, the receiver bi-fold antenna 404 can be physically smaller that the transmitter bi-fold antenna 402. The larger size of the transmitter bi-fold antenna 402 allows improved control of the beam steering for tracking the satellite 104, while assuring that sufficient power is applied to the up-link satellite packet 122. The size of the receiver bi-fold antenna 404 can be limited because of the integrated components of the satellite Rx/Tx 114 limit the distance that the low power RF signal, of the down-link satellite packets 121, must travel before the RF signal is amplified.

Continuing with the example, the steerable beam phase array antenna 112 can have an extended antenna length 406 in the range of 350 mm to 400 mm and an antenna width 408 in the range of 200 mm to 230 mm. An antenna thickness 410 of the steerable beam phase array antenna 112 can be in the range of 40 mm to 80 mm, as measured along the edge between the top surface 322 and the bottom surface 324. The transmitter bi-fold antenna 402 can have an extended length 412 in the range of 250 mm to 270 mm. The receiver bi-fold antenna 404 can have an extended length 414 in the range of 130 mm to 150mm. The steerable beam phase array antenna 112 can also be folded for storage or transport by folding both the transmitter bi-fold antenna 402 and the receiver bi-fold antenna 404 by the hinges 308. A folded antenna length 416 can be in the range of 180 mm to 240 mm and a folded height in the range of 120 mm to 240 mm.

It has been discovered that the steerable beam phase array antenna 112 can support transmitting the up-link satellite packet 122 and receiving the down-link satellite packets 121 from the satellite 104, in the LEO position, in both the Ku frequency spectrum and the Ka frequency spectrum without alteration. The steerable beam phase array antenna 112 can be controlled through the power control port 306 to provide beam steering and selective communication and tracking of the satellite 104. By folding the steerable beam phase array antenna 112, the parasitic layer 202 of the transmitter bi-fold antenna 402 and the receiver bi-fold antenna 404 can be protected and the size of the steerable beam phase array antenna 112 can be reduced for storage or transport.

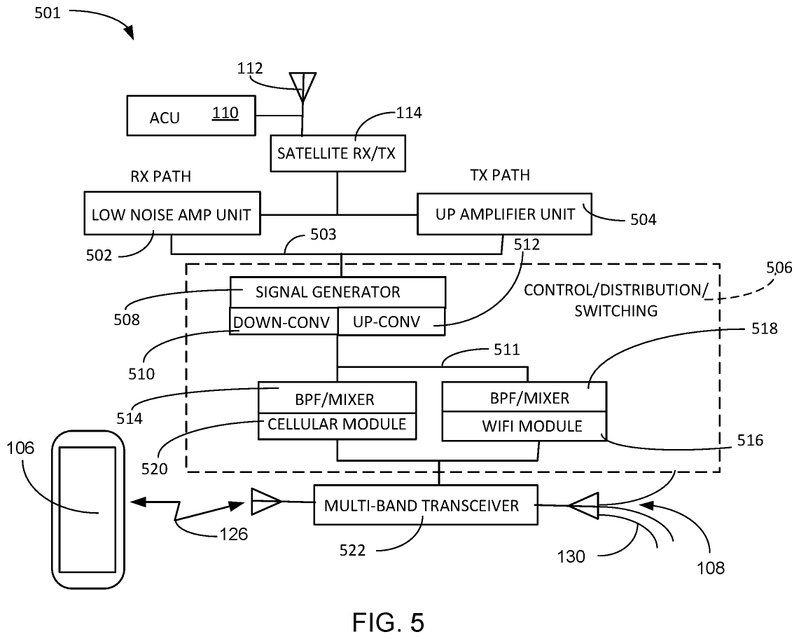

Referring now to FIG. 5, therein is shown an architectural block diagram 501 of the satellite interface unit 102 in an alternative embodiment of the present invention. The architectural block diagram 501 of the satellite interface unit 102 depicts the steerable beam phase array antenna 112 coupled to the satellite Rx/Tx 114 and the antenna control unit 110. The antenna control unit 110 can provide beam steering and tracking of the satellite 104 through the steerable beam phase array antenna 112.

A low-noise amplifier unit 502 can be in the receiver path in order to boost the received signal level. An up-amplifier unit 504 can boost the signal voltage in the transmission path to the satellite Rx/Tx 114. It is understood that in some configurations of the satellite interface unit 102, the low-noise amplifier unit 502 and the up-amplifier unit 504 can be integrated into the steerable beam phase array antenna 112. The low-noise amplifier unit 502 can be an analog circuit configured to raise the signal level without introducing electrical noise into a satellite frequency 503. The up-amplifier unit 504 can be an analog circuit configured to raise the voltage level of an encoded signal, at the satellite frequency 503, in preparation for sending the up-link satellite packet 122 of FIG. 1 to the satellite 104 of FIG. 1. By integrating the low-noise amplifier unit 502 and the up-amplifier unit 504 into the steerable beam phase array antenna 112, the down-link satellite packets 121 and the up-link satellite packet 122 will be less susceptible to electrical noise due to shorter transfer lengths of the unamplified signals.

A control/distribution/switching module 506 can process the down-link satellite packets 121 of FIG. 1 and generate the frequency and data content for the up-link satellite packets 122. The control/distribution/switching module 506 can be an application specific integrated circuit (ASIC) that includes a signal generator 508 for generating and tracking the reference frequency for encoding/decoding the data sent to or received from the satellite 104.

A low-noise block downconverter 510 can serve as the RF front end of the satellite Rx/Tx 114, receiving the microwave signal from the satellite 104, amplifying it, and down-converting the block of frequencies to a lower block of intermediate frequencies (IF). The low-noise block downconverter 510 can be a hardware circuit tuned for reducing the frequencies received from the satellite 104 to a more easily routable internal frequency 511. It is understood that the internal frequency 511 can be decades lower frequency than the satellite frequency 503.

In the transmission path, a block up-converter 512 can receive encoded messages at the internal frequency 511 and boost the frequency of the encoded messages to the satellite frequency 503. The block up-converter 512 can be a hardware circuit capable of combining the encoded messages at the internal frequency 511 with the reference frequency generated by the signal generator 508 to produce the encoded messages at the satellite frequency 503.

A band pass filter (BPF)/mixer 514 can condition messages that are processed by a WiFi module 516 that can support 802.11 b/g/n for providing Internet access through the WiFi hotspot 108 of FIG. 1. The BPF/mixer 514 and the WiFi module 516 are both hardware modules that work together to transfer the WiFi packets 130 of FIG. 1. An additional band pass filter (BPF)/mixer 518 can condition messages that are processed by a cellular module 520. The additional BPF/mixer 518 and the cellular module 520 are both hardware modules that work together to transfer the cellular communication packets 126 of FIG. 1. The cellular module 520 can support several communication standards including 3G, 4G, long term evolution (LTE), and 5G. It is understood that other communication standards can be implemented.

Both the WiFi module 516 and the cellular module 520 can be coupled to a multi-band transceiver 522 that can boost the power of the WiFi packets 130 and the cellular communication packets 126 for communication with external devices including the communication device 106 and the WiFi hotspot 108. The multi-band transceiver 522 can be a hardware module capable of transmitting and receiving messages at different frequencies and having different content. The multi-band transceiver 522 can provide sufficient power to broadcast the content from the WiFi module 516 and the cellular module 520. The multi-band transceiver 522 can produce the WiFi packets 130 including wireless Internet signals having a frequency of 2.4 GHz.

It is understood that the satellite interface unit 102 can include the power module 116 of FIG. 1 in order to provide the energy required to power the hardware circuits for communicating between the satellite 104, the communication device 106, the WiFi hotspot 108, and extend the battery life of the communication device 106. It is further understood that additional interface modules can be installed in order to support specific communication structures not listed above.

It has been discovered that the satellite interface unit 102 can provide a number of communication services without the use of the local infrastructure 105 that may be damaged or without the power required to operate normally. The satellite interface unit 102 provides a communication base for exchanging information between the satellite 104, the communication device 106, the WiFi hotspot 108, or a combination thereof, that can support a few people, such as first responders, aid workers, emergency medical technicians, or a small town with hundreds of people. The satellite interface unit 102 can act as a temporary base for all emergency communication to provide a WiFi zone of at least 1 km. The satellite interface unit 102 can also provide a communication structure for a residence that is off-the-grid and has no wired power available.

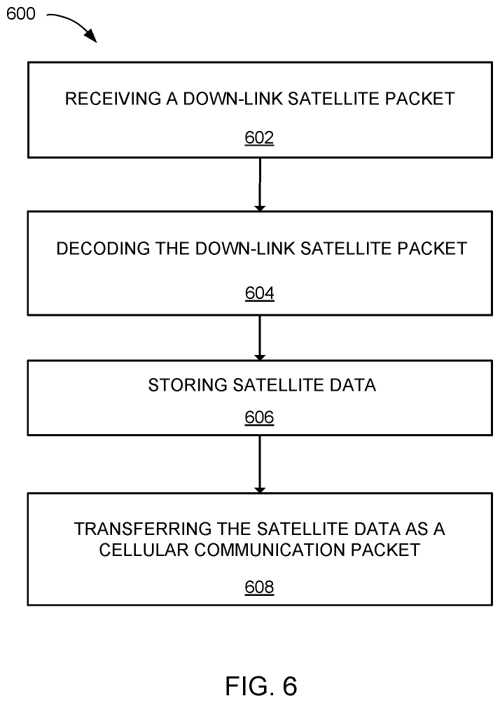

Referring now to FIG. 6, therein is shown a flow chart of a method 600 of operation of the communication system 100 in an embodiment of the present invention. The method 600 includes: receiving a down-link satellite packet through a parasitic layer and a waveguide interposer of a steerable beam phase array antenna in a block 602; decoding the down-link satellite packet in a block 604; storing satellite data decoded from the down-link satellite packet in a block 606; and encoding and transferring the satellite data as a cellular communication packet, a WiFi packet, or a combination thereof when a local infrastructure is non-accessible in a block 608.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A communication system comprising:
a satellite interface unit including:
a steerable beam phase array antenna configured to receive a down-link satellite packet, wherein the steerable beam phase array antenna includes a parasitic layer and a waveguide interposer, a satellite Rx/Tx, coupled to the steerable beam phase array antenna, configured to decode the down-link satellite packet, a storage device, coupled to the satellite Rx/Tx, configured to store satellite data decoded from the down-link satellite packet, and an interface module, coupled to the storage device, configured to encode and transfer the satellite data as a cellular communication packet, a WiFi packet, or a combination thereof when a local infrastructure is non-accessible.

2. The system as claimed in claim 1, wherein the satellite interface unit includes a second interface module configured to support a WiFi hotspot.

3. The system as claimed in claim 1, wherein the satellite interface unit includes an antenna control unit configured to track and selectively communicate with a satellite.

4. The system as claimed in claim 1, wherein the steerable beam phase array antenna is configured to pass the down-link satellite packet includes receiving a frequency in the range of 27.5 GHz to 32.5 GHz when a satellite is in Low Earth Orbit (LEO).

5. The system as claimed in claim 1, wherein the steerable beam phase array antenna includes:
a hinge configured to fold a transmitter bi-fold antenna; and
the hinge configured to fold a receiver bi-fold antenna to protect the parasitic layer.

6. The system as claimed in claim 1, wherein the satellite interface unit includes the steerable beam phase array antenna configured to track the satellite in Low Earth Orbit (LEO).

7. The system as claimed in claim 1, wherein the satellite interface unit includes a unit controller configured to convert satellite data into the cellular communication packet.

8. The system as claimed in claim 1, wherein the interface module configured to transfer the satellite data as the cellular communication packet includes accepting 3G, 4G, long term evolution (LTE), 5G, or a combination thereof through the cellular communication packet.

9. The system as claimed in claim 1, wherein the satellite interface unit further comprises a unit controller configured to convert satellite data into the WiFi packet.

10. The system as claimed in claim 1, wherein the steerable beam phase array antenna configured by unfolding a receiver bi-fold antenna and a transmitter bi-fold antenna coupled to the satellite interface unit.

11. A method of operation of a communication system comprising:
receiving a down-link satellite packet through a parasitic layer and a waveguide interposer of a steerable beam phase array antenna;
decoding the down-link satellite packet;
storing satellite data decoded from the down-link satellite packet; and
encoding and transferring the satellite data as a cellular communication packet, a WiFi packet, or a combination thereof when a local infrastructure is non-accessible.

12. The method as claimed in claim 11 wherein encoding and transferring the satellite data including coupling the storage device to a second interface module, configured to support a WiFi hotspot.

13. The method as claimed in claim 11 further comprising tracking a satellite by an antenna control unit coupled to the steerable beam phase array antenna.

14. The method as claimed in claim 11 wherein receiving the down-link satellite packet in the range of 27.5 GHz to 32.5 GHz through the steerable beam phase array antenna with the satellite in Low Earth Orbit (LEO).

15. The method as claimed in claim 11 further comprising unfolding a transmitter bi-fold antenna and a receiver bi-fold antenna of the steerable beam phase array antenna for receiving the down-link satellite packet.

16. The method as claimed in claim 11 wherein receiving the down-link satellite packet by coupling a steerable beam phase array antenna to the satellite including the steerable beam phase array antenna configured to track the satellite in Low Earth Orbit (LEO).

17. The method as claimed in claim 11 further comprising converting satellite data into the cellular communication packet by a unit controller.

18. The method as claimed in claim 11 wherein transferring the satellite data as the cellular communication packet includes accepting 3G, 4G, long term evolution (LTE), 5G, or a combination thereof through the cellular communication packet.

19. The method as claimed in claim 11 further comprising converting satellite data into the WiFi packet by a unit controller.

20. The method as claimed in claim 11 further comprising unfolding a receiver bi-fold antenna and a transmitter bi-fold antenna, to form the steerable beam phase array antenna, coupled to the satellite interface unit.
